(19) United States
(12) Patent Application Publication
(10) Pub. No.: US 2003/0002778 A1
(43) Pub. Date: Jan. 2, 2003

(54) Photo-polymer based fiber-optic switch using total internal reflection and micro-fluidic actuation

(76) Inventors: David Bach, Ellicott City, MD (US); Bob Furmanak, Cochranville, PA (US); Ben Ellerbusch, West Chester, PA (US); Bruce Booth, West Chester, PA (US); John Gallo, Newtown Square, PA (US)

Correspondence Address: DRINKER BIDDLE & REATH, LLP, One Logan Square, 18th and Cherry Streets, Philadelphia, PA, 19103, US

(21) Appl. No.: 10/075,632

(22) Filed: Feb. 13, 2002

Related U.S. Application Data
(60) Provisional application No. 60/268,712, filed on Feb. 14, 2001.

(51) Int. Cl. G02B 6/35

(52) U.S. Cl. 385/16; 385/17

(57) ABSTRACT

An optical channel switching element routes optical signals between optical waveguides or optical fibers by creating a transmit or reflect state in a polymer waveguide crossing junction by utilizing Total Internal Reflection (TIR) off a trench placed between the waveguide paths. The presence of a fluid or gel (usually selected to match the waveguide refractive index) within the trench creates a transmit state (no light is reflected) allowing light to continue along the initial waveguide path. The lack of index matching fluid at the waveguide junction, or presence of an air bubble, creates a TIR state (all light is reflected and none is transmitted) causing the light to reflect off of the trench and continue along the path of the crossing guide.

This application claims priority from a provisional application, serial no. 60/268,712, filed on Feb. 14, 2001.

### FIELD OF THE INVENTION

This invention relates to the field of optical communications circuits and components.

### SUMMARY OF THE INVENTION

An optical channel switching element routes optical signals between optical waveguides or optical fibers by creating a transmit or reflect state in a polymer waveguide crossing junction by utilizing Total Internal Reflection (TIR) off a trench placed between the waveguide paths. The presence of a fluid or gel (usually selected to match the waveguide refractive index) within the trench creates a transmit state (no light is reflected) allowing light to continue along the initial waveguide path. The lack of index matching fluid at the waveguide junction, or presence of an air bubble, creates a TIR state (all light is reflected and none is transmitted) causing the light to reflect off of the trench and continue along the path of the crossing guide.

### DESCRIPTION OF THE DRAWINGS

FIG. 1 is a schematic representation of an optical fluid-controlled switch in its reflecting state.

FIG. 2 is a schematic representation of an optical fluid-controlled switch in its conducting state.

FIG. 3 is a schematic representation of an optical fluid-controlled polymer waveguide switch configured as a 4×8 crosspoint switch.

FIG. 4 is schematic of a waveguide.

FIG. 5 is a schematic of one embodiment of the invention.

FIG. 6 is a schematic of a second embodiment of the invention.

FIG. 7 is a schematic of a waveguide junction exhibiting optical signal loss.

FIG. 8 is a schematic of a waveguide junction configured to reduce loss.

FIG. 9 is a schematic of a microtomed waveguide element connection.

FIG. 10 is a schematic of a mictrotomed waveguide connection.

FIG. 11 is a schematic of an embodiment of the invention having a displaced trench formation.

FIG. 12a is a schematic of an embodiment of the invention in the open switch condition.

FIG. 12b is a schematic cross-section of the actuator of the fluid reservoir.

FIG. 13a is a schematic of an embodiment of the invention having an alternative actuator design.

FIG. 13b is a schematic of an alternative actuator design.

FIG. 14 is a schematic of an alternative embodiment of the invention in the open switch condition.

FIG. 15 is a schematic of an alternative embodiment of the invention in the closed switch condition.

FIG. 16 is a schematic of an alternative embodiment of the invention in the open switch condition.

FIG. 17 is a schematic of an alternative embodiment of the invention in the closed switch condition.

FIG. 18 is a schematic of an embodiment of the actuator controlling an embodiment of the invention.

FIG. 19 is a schematic of an alternative embodiment of an actuator controlling an alternative embodiment of the invention.

FIG. 20 is a schematic cross section of an actuator for the present invention.

FIG. 21 is a schematic cross section of an actuator for the present invention.

FIG. 22 is a schematic of an embodiment of the invention connected by fiber pigtailing means.

FIG. 23 is a schematic cross section of a fiber pigtailed connection according to the invention.

FIG. 24 is a schematic drawing of the piezo activating element mounting assembly.

FIGS. 25a and b are representations of oscilloscope traces of the piezo element response when the supply lead is grounded (a) and floating (b).

### DETAILED DESCRIPTION OF THE INVENTION

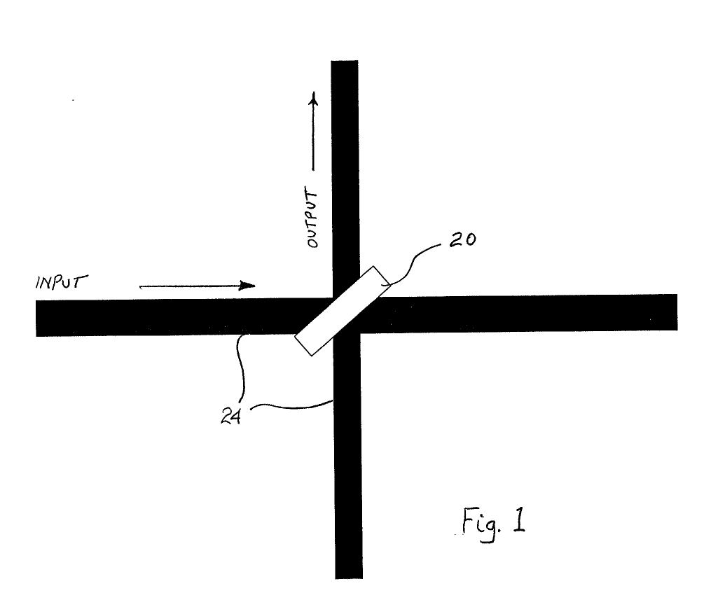

An illustration of an optical channel switching element is shown schematically in FIG. 1. The switch of FIG. 1 is shown in its reflecting state where the resulting input and output signal paths would take the configuration shown. The junction of the signal waveguides 24 is shown in an air (or other suitable substance) reflect state where the optical signal input is reflected off the trench 20 and continues in the output path shown. This switching function may be employed with single-mode (SM) or multimode (MM) waveguides.

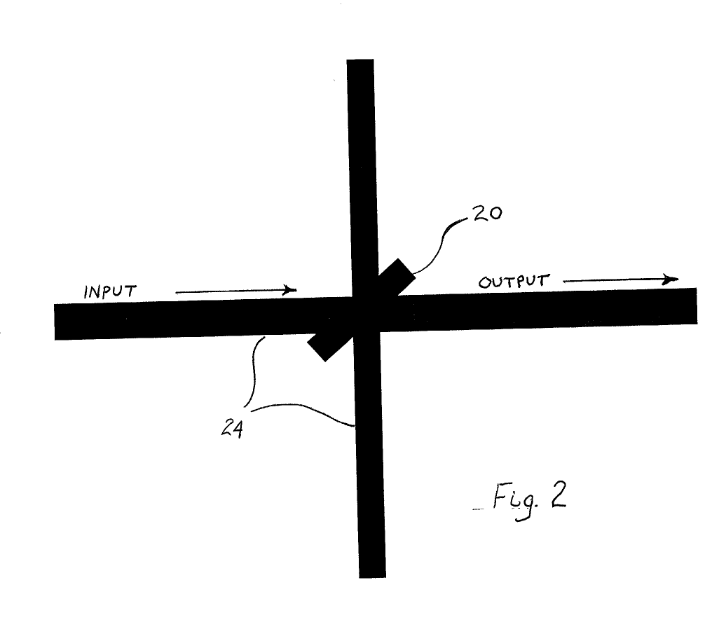

FIG. 2 illustrates the switch of FIG. 1 in the fluid conducting state. In this state the input signal through the waveguide 24 is conducted through the trench 20 by fluid transmission.

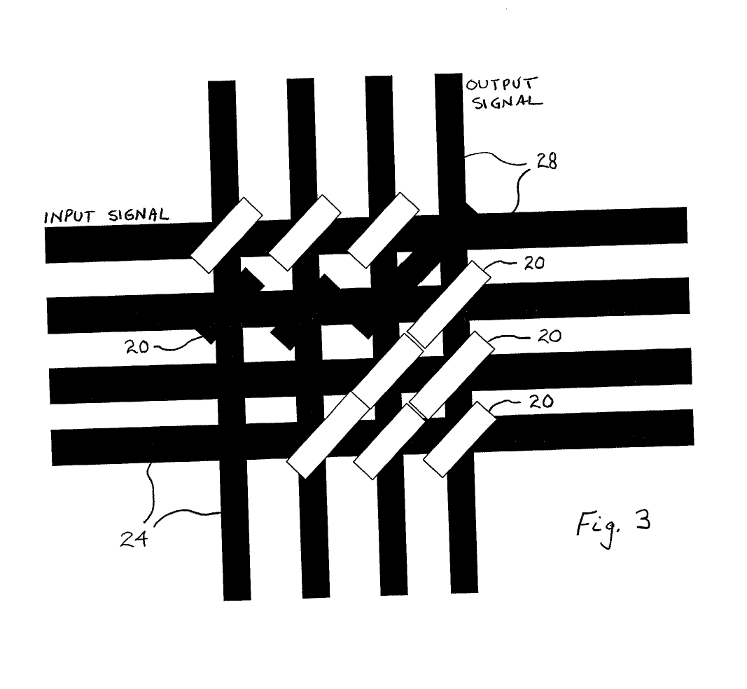

The concept of an optical switch based on Total Internal Reflection (TIR) is not new (originally proposed by J. Jackel at Bellcore circa 1980), and various methods exist for the creation of air or fluid bubbles in the trench. However, many shortcomings exist in these designs that can be overcome resulting in higher switching speeds, lower switch losses (per node), and reduced polarization dependent loss (resulting from non-symmetry in waveguide design). In the desired configuration, these individual switching nodes would be applied in a matrix to create high-port count switches (8×8, 32×32, etc.). An implementation of the switch matrix is shown in FIG. 3 for a 4-input, 8-output crosspoint device. The FIG. 3 device has multiple input waveguides 24 and output waveguides 28, with a trench 20 at each junction.

The switching approach of the present invention utilizes low-loss optical waveguides (single or multi-mode) formed in a photo-sensitive polymer, combined with novel trench formation and fluid movement techniques, to achieve high speed channel switching with minimum induced optical loss. Various waveguide designs can also be implemented to further reduce optical losses in the polymer that cannot be applied in other materials. Some of the original design elements include: low-loss, polymer-based, Total Internal Reflection switch; piezoelectric or magnetic actuation for high-speed fluid movement; original approaches towards bubble placement; novel trench formation techniques; precision fiber alignment techniques; and adiabatic waveguide numerical aperture (width or refractive index) tapers.

Waveguide Formation in Photo-Sensitive Polymers

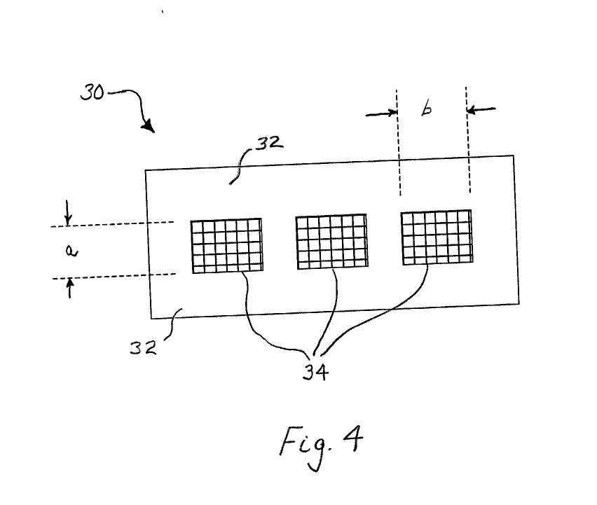

An important element in the polymer-based, optical switch is the polymer host itself. In the design of the invention, a photo-sensitive polymer is used along with a standard chrome-on-quartz photomask and UV exposure to create square, or rectangular, waveguides for either single-mode (SM) or multi-mode (MM) applications. The index difference induced by the UV exposure depends upon the exposure energy used and other processing parameters. The resulting SM waveguide possesses a highly circular mode field resulting in near zero insertion loss for fiber-to-waveguide or waveguide-to-fiber coupling. FIG. 4 shows a schematic representation of a symmetric, polymer waveguide formed using the fabrication technique mentioned with two unexposed cladding layers 32 and a core/clad layer with three waveguide cores 34. By example and for reference only, the dimensions of the waveguide cores can range from about 6 to about 50 microns for dimensions a and b shown in FIG. 4., while the cladding layers may be about 37.5 to 60 microns thick.

In addition to being well mode-matched to SM and MM fiber, this type of waveguide also possesses low propagation losses from 600-1300 nm (<0.4 dB/cm) with a slightly increased propagation loss at 1550 nm (˜0.7 dB/cm), and with the appropriate, high-density switch array designs, arrays with >8 output channels can be implemented with ˜1-2 cm of waveguide propagation allowing for switch array insertion losses of about 1 dB (wavelength dependent). The photo-sensitive polymer approach also allows for the implementation of unique index profiles which will be discussed further in the Waveguide Design section below.

Waveguide Design

One distinct advantage of the use of the photo-sensitive waveguide material is that it allows for the fabrication of both planar single-mode and multi-mode circuits. Most thin-film deposition-based waveguide approaches are unable to sufficiently construct the large 35-50 micron thick layers needed into low-loss planar waveguide structures without detrimental stresses, fractures, or other defects. The photo-sensitive polymer waveguides are capable of being fabricated to thicknesses >100 microns and can therefore be used as large, planar light guides with dimensions of 100s microns by 100s of microns and more. This capability is unique to this waveguide manufacturing approach and makes it the key player in short-range datacom and other multi-mode fiber based communications systems. This advantage is further increased due to the shorter wavelength of operation of these types of systems (typically ˜800 nm) that corresponds to the low-loss (<0.1 dB/cm) wavelength range of operation for the polymer waveguides.

Given the extremely flexible nature of waveguide formation in the photosensitive polymer, there are two waveguide design approaches that can be implemented to minimize the insertion loss of light passing through or reflecting off the trench in a single-mode device. These changes are in addition to the trench improvements mentioned in the following section—Trench Design and Formation. The goal of these changes is to adiabatically (with no induced optical loss) reduce the numerical aperture (NA) of the waveguide as it is incident on the trench. This reduces the diffractive losses of the signal as it propagates through the fluid. A reduction in NA can be achieved in two ways in the photosensitive polymer waveguides. A one-dimensional reduction is achieved by increasing the width of the incident waveguide to the maximum width for single-mode operation.

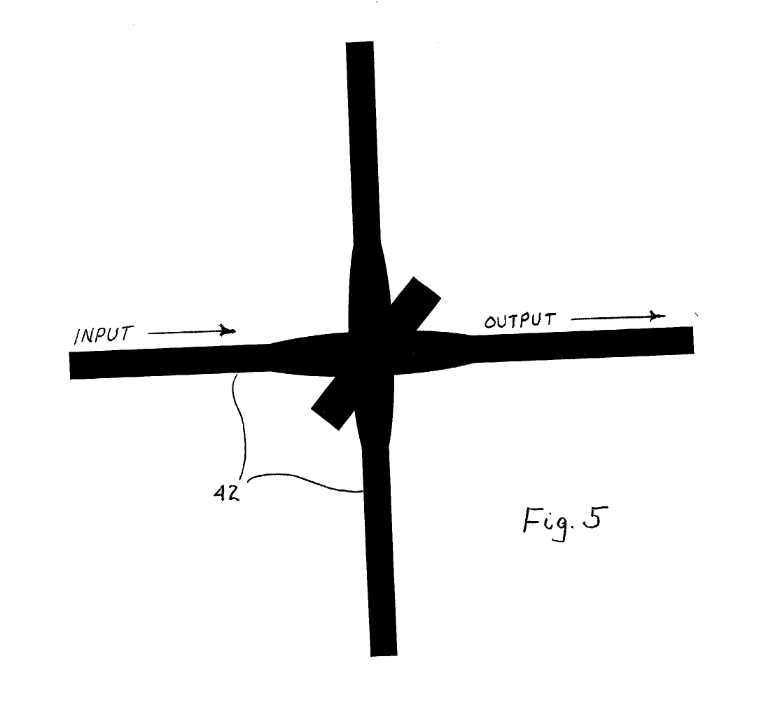

FIG. 5 shows a waveguide junction implementing the waveguide width taper designed to reduce insertion loss of the junction. FIG. 5 shows a one dimensional NA taper at the junction of the waveguides 42.

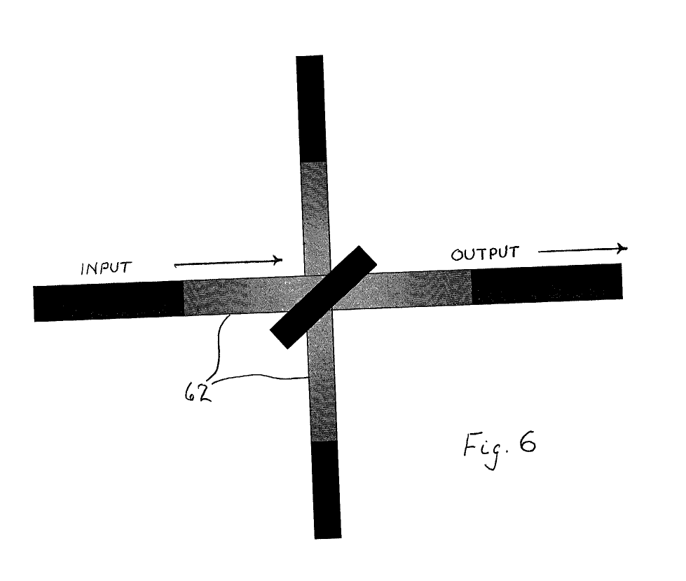

A two-dimensional increase in NA can also be readily achieved in the photosensitive polymer using a gray scale mask and refractive index tapering. FIG. 6 shows the implementation of an index taper. By reducing the exposure intensity of the waveguide 62 near the junction (darker=higher optical density guide region on gray-scale mask; lighter=less optical density), the index difference between the guide core and cladding is reduced in two-dimensions (thus reducing the NA of the guide) minimizing the diffractive losses that occur by crossing the trench. This novel approach is a unique capability of the photosensitive polymer waveguides.

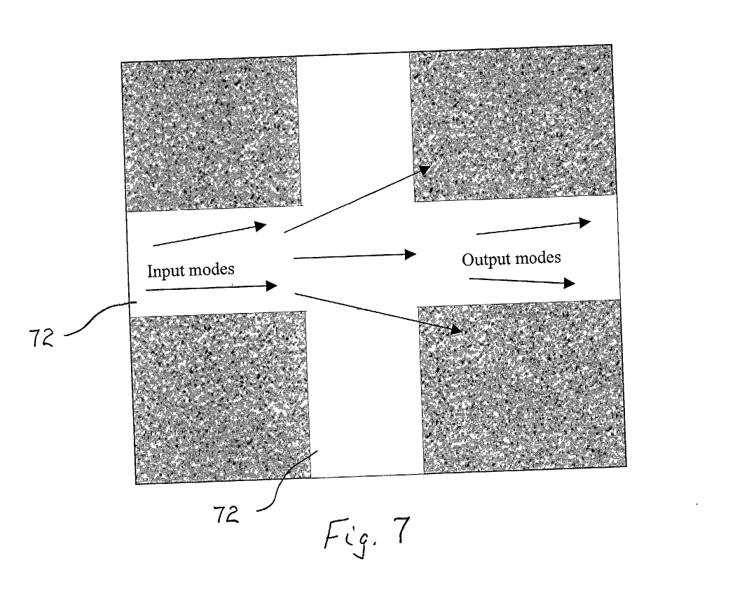

Improvements in multi-mode junction performance can also be obtained by implementing a slight design change also designed to reduce the diffractive losses of high order modes in the waveguide crossing region. This approach is ideally suited to the photosensitive waveguide formation approach used in these polymer waveguides. The problem being addresses is schematically represented in FIG. 7 where high-order (high-angle) modes propagating in the incoming MM-waveguide are unable to be efficiently transmitted or reflected after passing through the wide waveguide region created by the waveguide intersection. These high-angle modes spread out in this wider region and are poorly collected by the desired output guide. The result is a lossy junction.

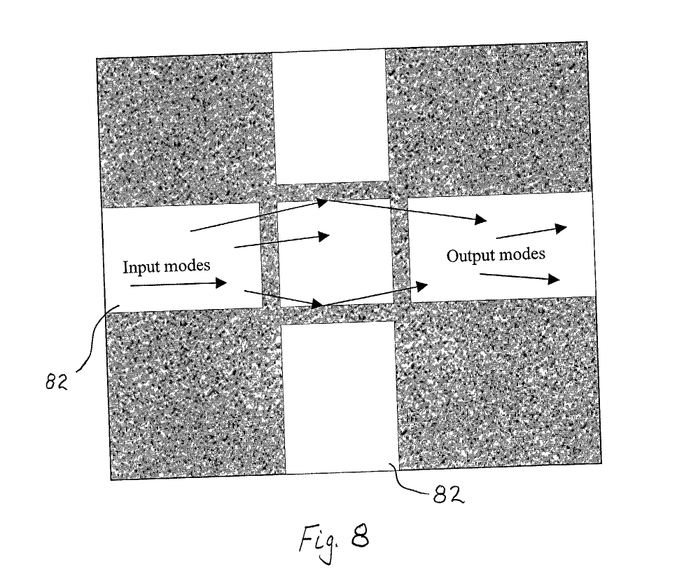

By creating slight index “barriers” at the waveguide junction, shown in FIG. 8, these high-angle modes continue to be guided in the initial waveguide region 82, allowing the higher order modes to be either transmitted across the trench or reflected off without the divergence losses resulting in a reduced insertion loss per switch node.

Trench Design and Formation

Previous optical switch approaches incorporating TIR required narrow (5-20 μm) trenches formed using reactive ion etching (RIE), or similar (e.g., chemical etching), techniques to create highly vertical sidewalls at the optical interface. These etching techniques induce large amounts of surface roughness that result in a poor reflection state, and therefore, high reflection state losses. Two new approaches for forming an optical grade (low roughness) trench interface reduce this loss, and these approaches, combined with the polymer host material, create a low-loss reflection state to go along with the inherently low-loss crossing (fluid) state. Proper trench design also allows for the precise placement of the fluid column (or air bubble) and can be used to increase the speed of the switching mechanism. These design considerations will also be discussed.

The first approach to optical quality trench formation involves a process known as microtoming. A microtome is typically used in medicine to shave thin (sub-micron to 10s of microns) thick samples of tissue from a larger sample for inspection of the cross-section. A cleaved, glass blade is used for cutting the material, and it is precisely fed into the sample using precision translation stage actuation. The cutting speed and feed-rate are typically controlled electronically. In the same way, this process can be used to slice thin pieces of the polymer material (<1 μm thick) creating optical-quality facets for low-loss reflection of light.

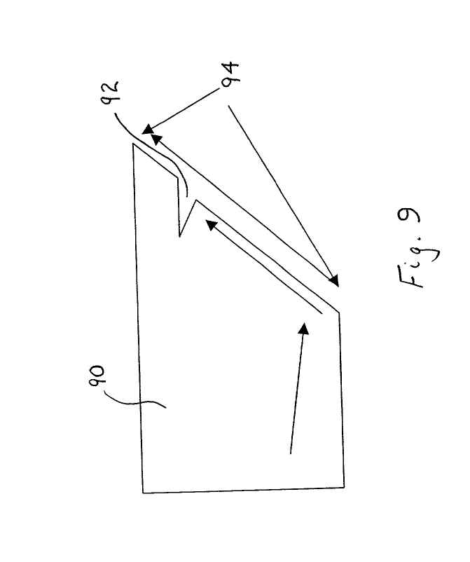

The microtome can also be used to set the proper trench width to as low as half a micron and wider than 20 microns. FIG. 9 illustrates the technique. First, the angle 94 of the microtome is set to be half that of the intersection angle between the waveguides 90 (45 degrees in the case of normally incident guides) and material is removed up to the waveguide intersection point.

Once within a few microns of the waveguide junction, a partial microtoming is performed for ˜5-10 microns up to a stop notch 92. When the two microtomed elements 90 are placed end-to-end, as in FIG. 10, the resulting gap between them is exactly as defined by the number and depth of the microtome cuts (5-10 microns typical). This approach results in optical quality facets, narrow trenches, and low-loss coupling. In the final configuration, upper and lower buffer layers would be added above and below the trench to seal it making it a small capillary-type cavity.

A second method for creating optical quality trench interfaces in the polymer is with precision laser ablation. This is also the necessary approach for large node count switches. Laser ablation involves vaporizing small regions (10-15 μm diameter holes) of polymer material using high-power excimer lasers focused to a minimum spot size and results in low surface roughness polymer facets. These narrow trenches can be placed, with the help of machine vision and properly designed alignment fiducials, with the necessary submicron precision resulting in low-loss reflect and transmit state switching nodes. By cascading these 1×2 switching elements in an appropriate array configuration, large n/2×n switch arrays can be achieved.

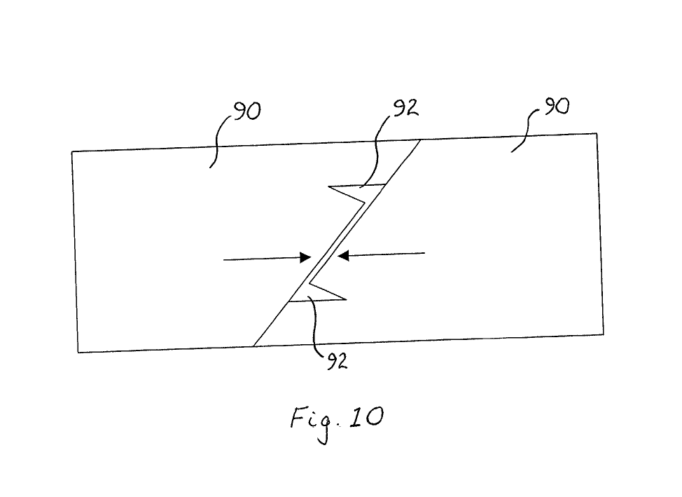

It should also be noted that additional performance improvements may be made by carefully placing the leading edge of the trench with respect to the waveguide junction. FIG. 11 illustrates a slight (1 μm) displacement of the leading edge 112 of the trench from the vertex of the waveguide intersection (towards the incoming waveguide) This displacement results in reduced junction loss in the reflect state. This is a result of the effective penetration of the light into the air filled trench upon reflection and the slight displacement improves the wave-front of the outgoing/reflected optical signal. FIG. 8 shows the proper placement 114 of the trench with emphasis on the slight displacement 112 from the vertex.

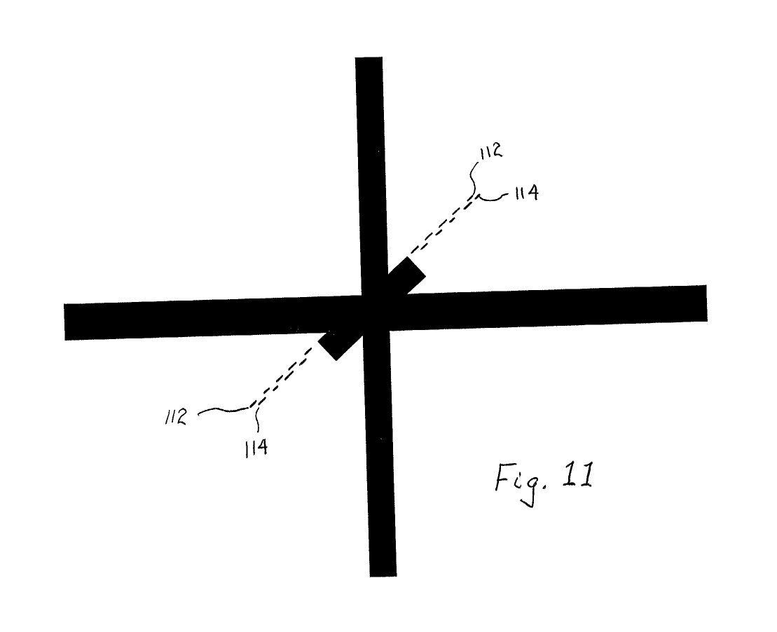

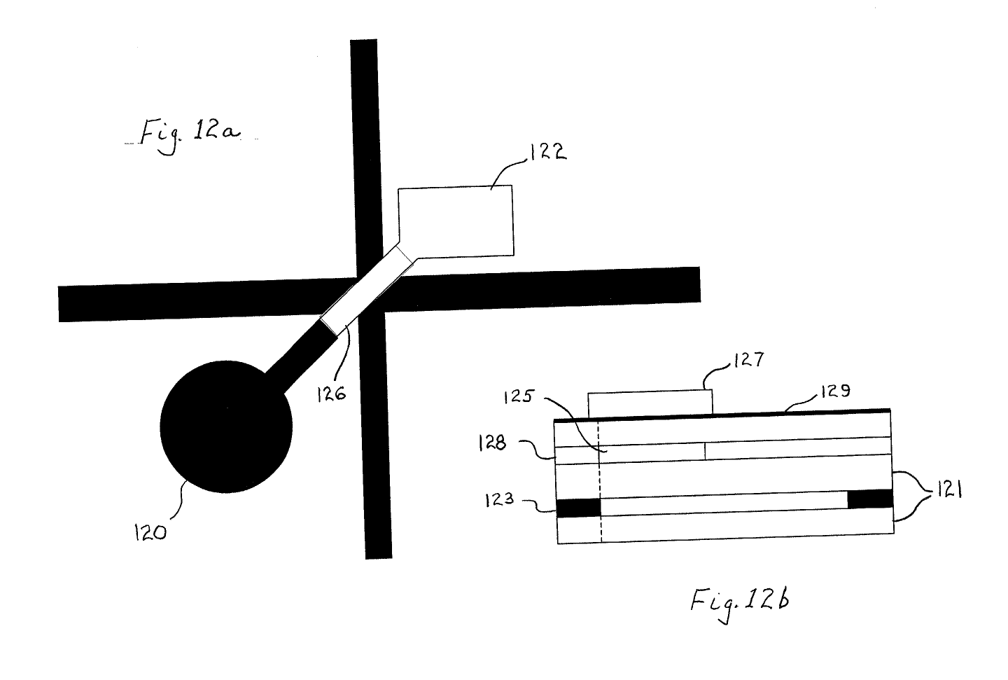

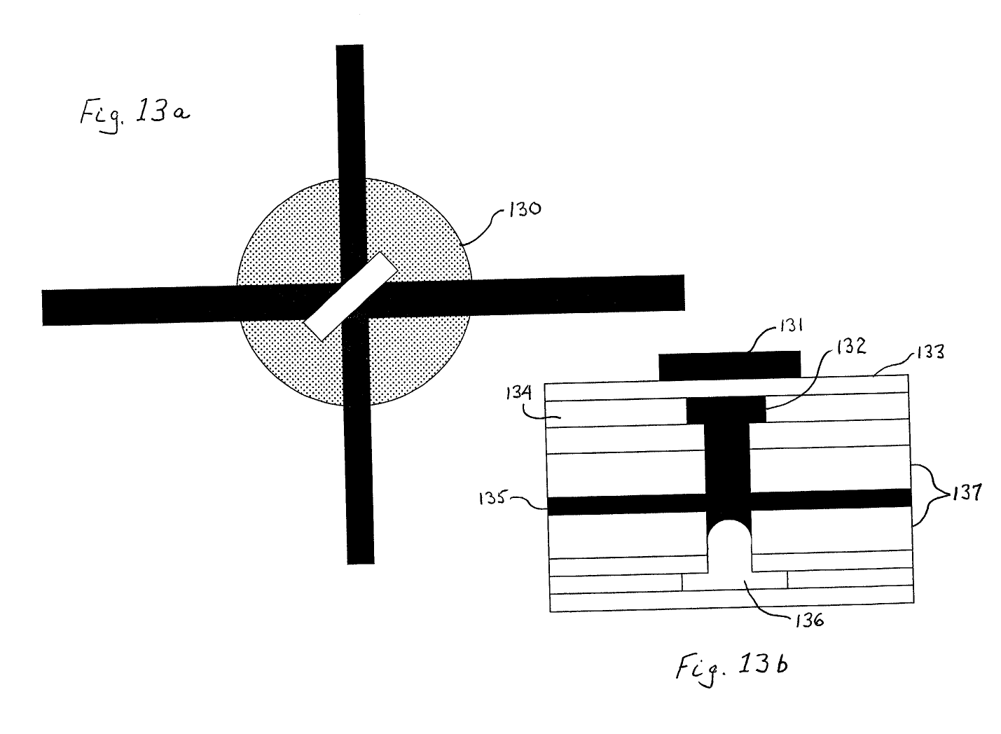

Given the ability to precisely place and define optical quality holes or trenches, several “plumbing” designs are readily achieved. The defining differences between the designs are in the direction of fluid movement. One approach, shown in FIGS. 12a and 12b, is to move the fluid into the waveguide junction by moving the fluid in the plane of the waveguides, or horizontally as shown. The other approach is to move the fluid vertically into and out of the waveguide plane, as shown in FIGS. 13a and 13b.

Each of these plumbing approaches presents various advantages and disadvantages. The vertical actuation approach shown in FIGS. 13a and b allows for a minimum amount of fluid displacement to achieve total coverage of the waveguide area, while the horizontal actuation, FIGS. 12a and b, of the fluid typically requires greater displacement. However, the use of in-plane, or horizontal, fluid movement allows for the formation of various reservoirs or trench dimensional changes that can be used as air reservoirs, fluid capillary stops, or fluid reservoirs. These can be used for precise fluid control—fluid/air interface placement—and for actuation reservoirs. Some of these fluid control designs will now be discussed further.

Several types of fluid/air interface can be used to create the reflect/transmit state of the TIR polymer switch—air bubble, fluid bubble, air column, fluid column—and each of these requires careful control over the position of the fluid/air interface. Without precise placement of this interface, different switches will have different speeds, or may not switch at all if the interface is beyond the range of actuation. Two novel methods for controlling this interface are presented here for the polymer TIR switch and these are 1) capillary action stoppage, and 2) air pressure stoppage.

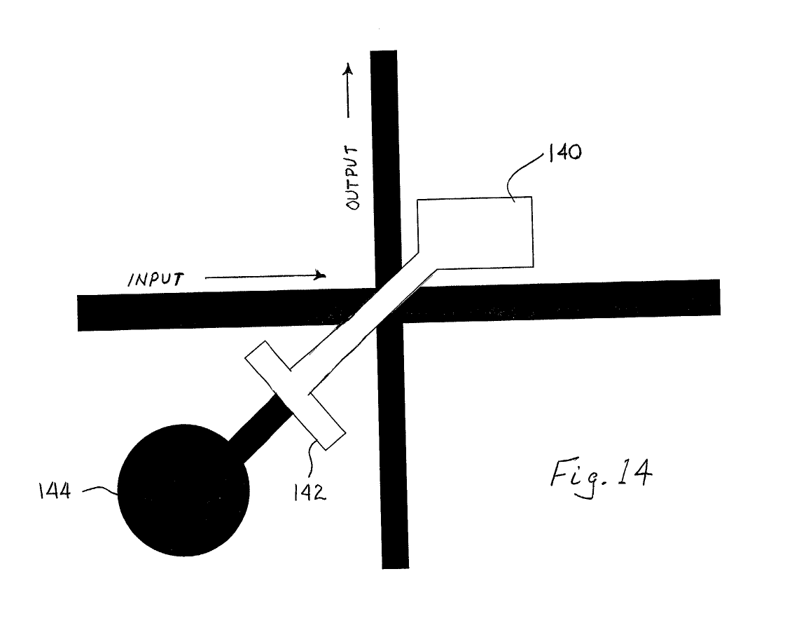

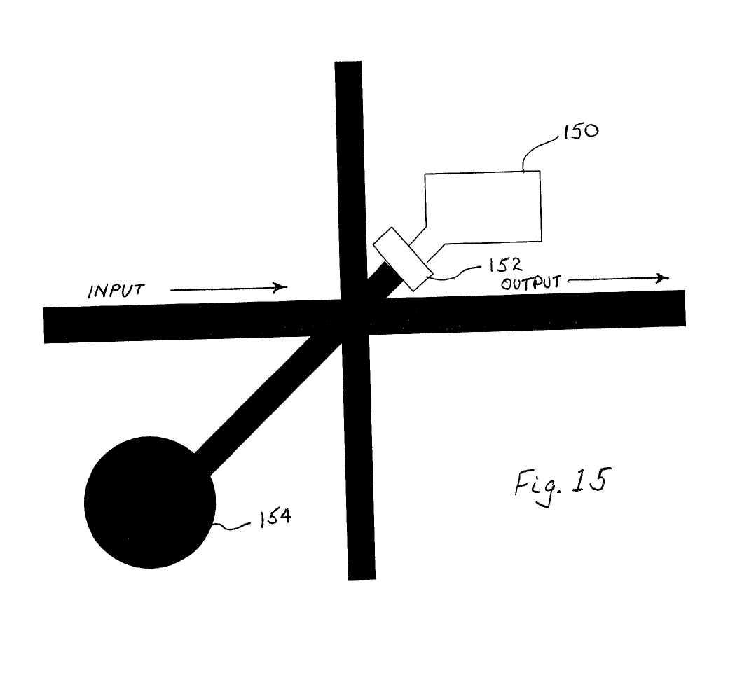

Because of the small dimensions of the trench (typically 10s of microns by 10s of microns), most index matching fluids will experience capillary action resulting in microfluidic movement through the trench. This capillary action can be utilized to perform controlled, uniform fluid filling of the trench as well as form the basis for stopping the movement and forming the fluid/air interface. Capillary action can be stopped by suddenly increasing the dimensions of the trench beyond the range of capillary action. FIGS. 14 and 15 give examples of how a capillary action stop can be implemented to define the fluid/air interface.

FIG. 15 is often a preferred method due to the lack of discontinuities prior to the waveguide junction. The presence of the capillary stop prior to the junction (FIG. 14) can create bubbles in the column (if not properly designed) resulting in a fluid/air emulsion with poor optical qualities.

One design concern worth noting when using a capillary stop is the need for an air reservoir with sufficient volume to allow the air in the trench to be compressed up to the capillary stop point. The force of the capillary action will, typically, compress an air volume by 10-20% in a ˜15 μm wide trench. The amount of compression will vary slightly with fluid type, ablation quality, and trench dimensions, however, allowing for near zero compression will give the maximum volume necessary to allow for fluid movement up to the capillary stop. This idea of air compression leads to a second fluid placement approach; an air pressure stop.

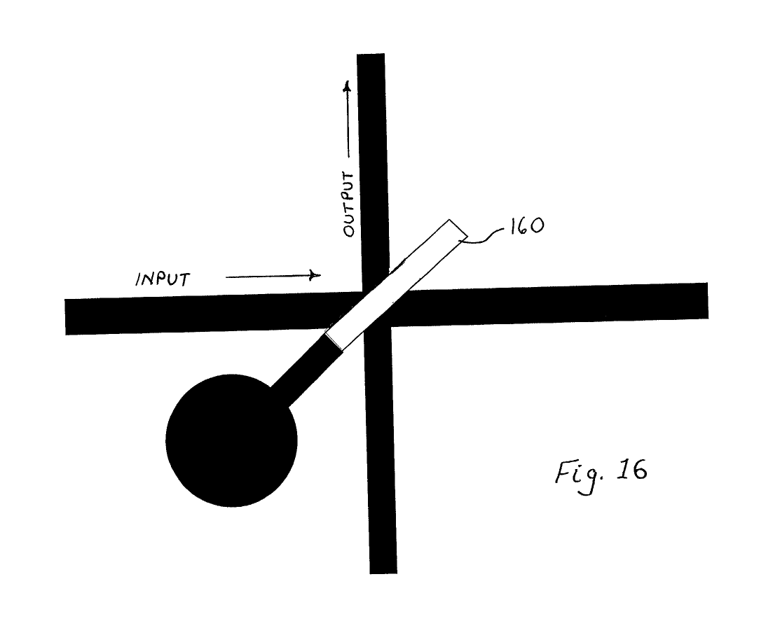

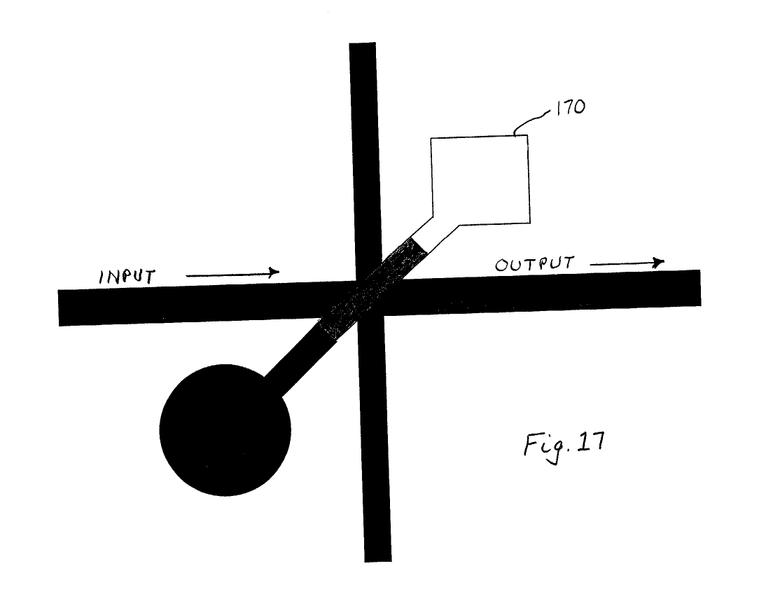

Once the force of the capillary action is understood, proper air reservoir volume design will allow the force of the compressed air in the air reservoir to balance, and stop, the capillary action of the index matching fluid in the trench. One advantage of this approach is that the fluid/air interface can be placed before or after the waveguide junction because it does not create trench discontinuities. This means that the column can be operated under the compression or expansion of a connecting fluid reservoir. FIGS. 16 and 17 show the two possible fluid/air interface configurations using the air compression fluid stop.

This fluid/air interface will remain stationary under environmental changes for two different reasons depending on the type of actuation reservoir used. If the actuation reservoir is fully filled with fluid (desired approach for maximum speed), the volume of fluid will not compress under the changing pressure of the air (after being sealed). If the actuation reservoir is not completely filled with fluid (small percentage of air), the change in environmental conditions will equally affect the two air volumes resulting in no net change in force (i.e., increase of air pressure in actuation reservoir equals change in air pressure in air reservoir). The importance of proper actuation reservoir design will be discussed further in the actuation reservoir design section.

Actuation Mechanism

The final functional element necessary for high-speed optical switching based on total internal reflection is a mechanism to move the fluid/air interface into and away from the waveguide junction. Various approaches have been implemented, with limited success, ranging from Agilent's ink jet approach of evaporating the fluid in the trench to thermally changing the capillary properties of the fluid causing more or less capillary action to take place (Journal of Lightwave Tech. Vol. 17, no. 1, January 1999). The bulk of these methods, being based on material temperature changes tend to be slower (>5 ms) than Micro-Electro-Mechanical System (MEMS), or other mechanically-based switching mechanisms (<5 ms). The two actuation approaches of the present invention are not thermally based and have the capability to provide switching times much faster than one millisecond, with typical switching times on the order of microseconds.

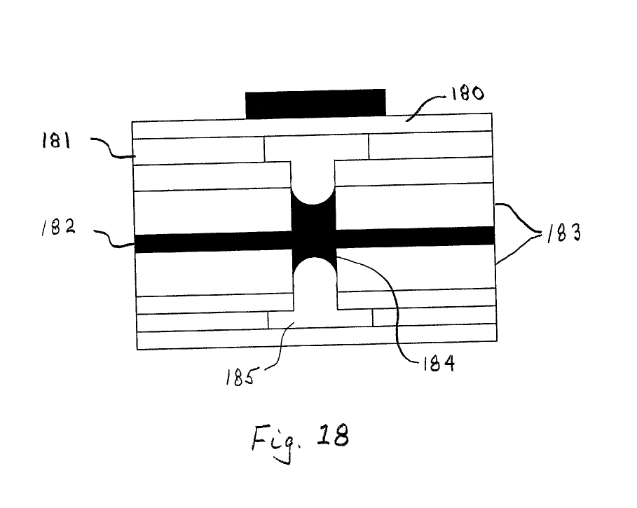

The first actuation mechanism involves the use of ferro-fluids as the index matching fluid and small electro-magnets/inductors to provide a varying magnetic field to push and pull the fluid away from the waveguide intersection. Ferro-fluids are simply fluids with small (10s of nanometers) magnetic particles suspended within the solution. The preferred trench approach for implementing this actuation mechanism is the vertical trench discussed previously and illustrated in FIG. 18.

A small column, or bubble, of ferro-fluid is suspended, via capillary action and air pressure in the small rectangular column, or trench, created by laser ablation. A small electro-magnet 188, most likely a mini-inductor, is positioned above the column and, upon the passing of current through the small inductor, a magnetic field is created and the column of fluid is either pulled up or pushed down depending upon the polarity of the field.

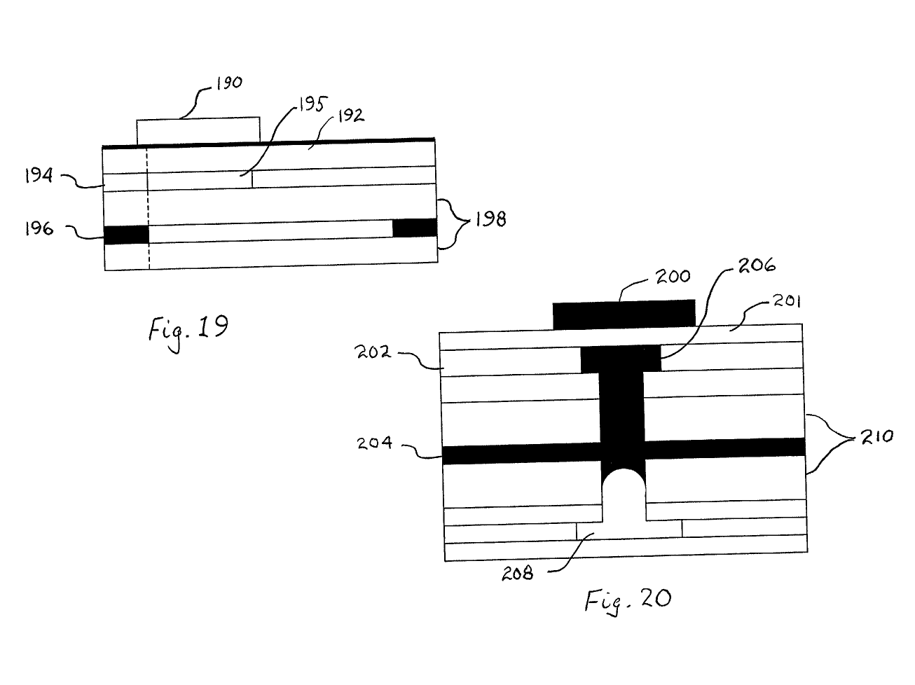

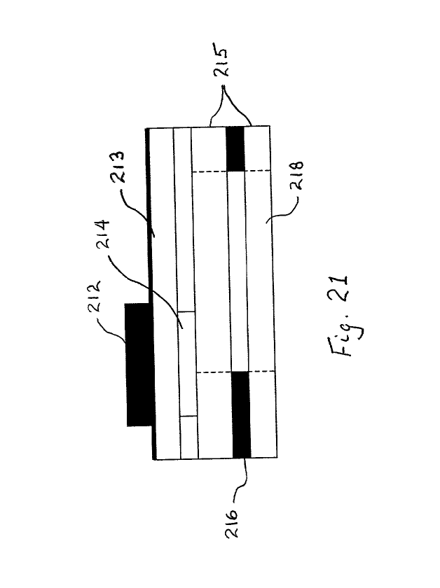

The second actuation mechanism for the polymer-based TIR switch is a piezoelectric driven micro-pump. A ceramic piezo-based bimorph disk 190 is used to move a flexible diaphragm 192 made of the photo-polymer (other materials such as polycarbonate may also be used), thus changing the volume of the reservoir beneath the actuator creating a pressure gradient on the fluid and the fluid/air interface resulting in micro-fluidic movement. The reservoir and layer design behind this implementation is shown in FIGS. 19 and 20. FIG. 19 shows a horizontal trench configuration with the actuation reservoir offset from the center of the waveguide junction, while FIG. 20 shows the implementation for a vertical trench configuration with the reservoir above the waveguide layer. Both implementations allow for controlled movement of the fluid towards and away from the waveguide junction.

The use of these small (<5 mm in diameter) piezo disks allows for sufficient diaphragm deflection and subsequent volume change to move the volume of fluid 10s of microns away from the waveguide junction and beyond the primary and evanescent fields of the optical signals. Piezo actuation, coupled with the inherent flexibility of the polymer material, provides for actuation speeds much less than 1 ms with potential switching times on the order of microseconds. The actual speed of switching is dependent upon fluidic properties and proper reservoir design. The critical elements of the reservoir design will now be discussed.

Actuation Reservoir Design

Utilization of piezo disk actuation requires careful attention to the actuation reservoir design. Since there is a limited amount of displacement available for a given piezo actuator, the amount of pressure gradient created by this displacement must be maximized. The ideal approach for this type of actuation requires the complete filling of the actuation reservoir with index matching fluid. This configuration is illustrated in FIG. 20. With this configuration, the entire piezo displacement is transferred to the fluid column near the waveguide intersection. This maximizes the speed of actuation and minimizes the displacement (and, therefore, applied voltage) needed from the piezo disk.

If filling of the actuation reservoir is incomplete, air bubbles will be present and will reduce the speed of the switch. This is due to the high compressibility of the air when compared to that of the index-matching fluid. Using the ideal gas law (PV=nRT), we know that the larger the initial volume of air present the greater the displacement needed to achieve a certain change in pressure. In order to maximize the change in pressure within the actuation reservoir, assuming the presence of air, one must minimize the initial air volume.

A novel approach was developed to specifically minimize the air in the actuation reservoir and this approach utilizes a polycarbonate “piston” mechanism that takes the place of the air reservoir. See FIG. 21. The piston is simply a circular disk cut out using laser ablation resulting in a ˜20 micron gap between the piston sidewall and the surrounding material. In this configuration, the only air remaining in the reservoir is that between the sidewalls of the piston and the surrounding material maximizing the speed and efficiency of actuation. This “piston” approach represented in FIG. 21 is a preferred actuation approach when piezo disk transducers are used and results in maximum actuation speed and control.

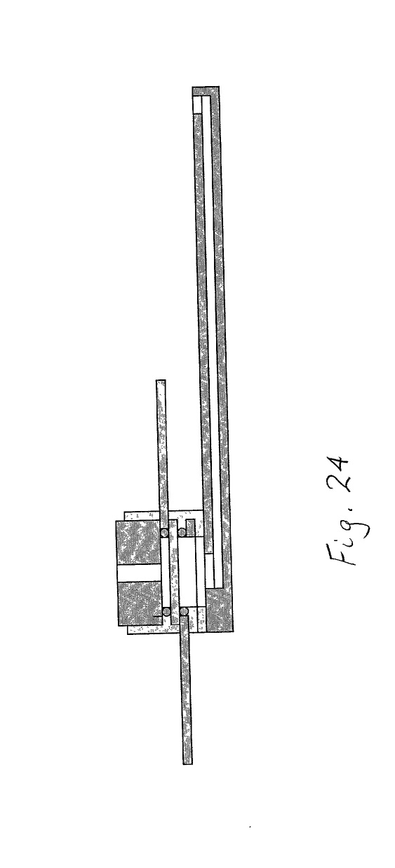

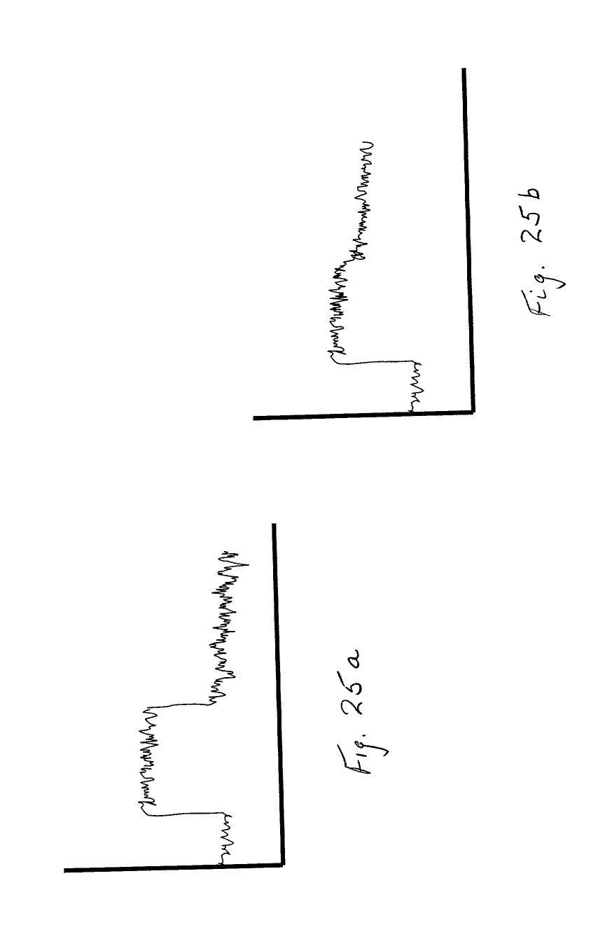

There are design considerations for mounting the piezo disk transducers in the actuator devices. The piezo disk should be mounted in a manner that the oscillations of the piezo element do not cause the assembly to fail. That is, if mounted in a rigid structure, the disk assembly can physically fail due to the physical stresses induced by the piezo oscillations. A mounting, such as with flexible O-rings, that absorbs these stresses enables the piezo actuator to withstand the stresses. The assembly illustrated in FIG. 24 shows the piezo device in an assembly with O-rings in the mounting structure. The piezo disk is mounted in the actuator with O-rings above and below.

The disc position can be locked into one position or another as shown in the two oscilloscope traces shown in FIGS. 25a and 25b. FIG. 25a, indicates the switch returns to its original state if the applied voltage is switched to ground. FIG. 25b, indicates that the switch exhibits a small amount of displacement when the voltage is removed, but not grounded.

Fiber Coupling and Pigtailing

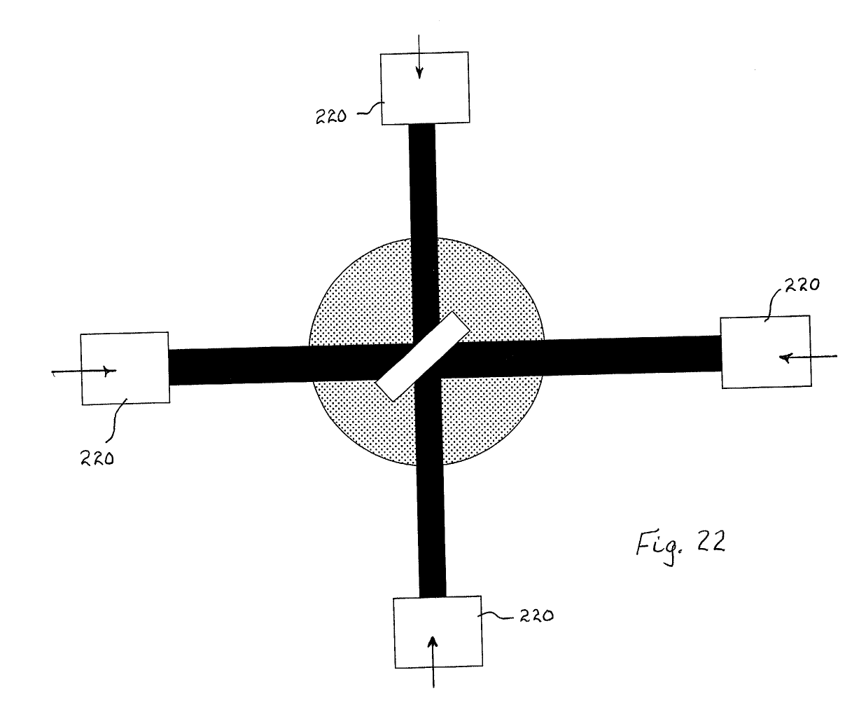

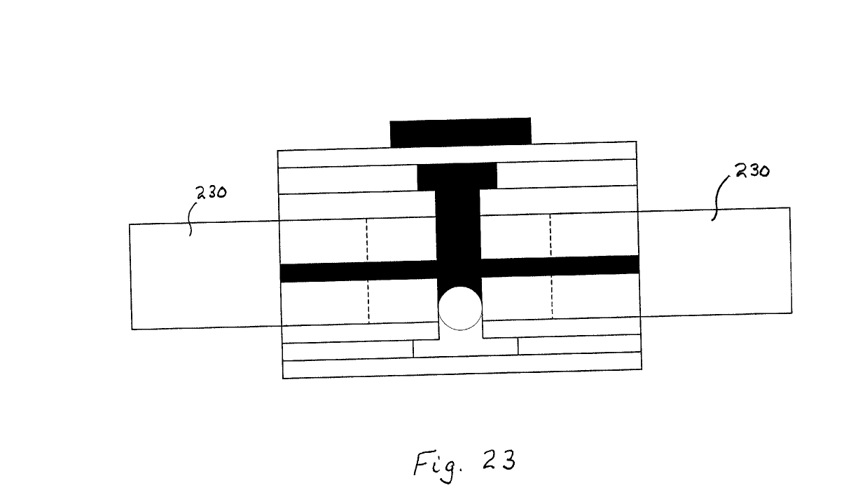

In order for an optical component such as the optical switch to be functional, one must be able to effectively couple it to the outside world, and that usually means fiber coupling or fiber pigtailing. This is typically a critical assembly step requiring sub-micron alignment of fibers with micro-mirrors or lenses and, if done poorly, can result in a significant increase in loss and reduced environmental resilience. This is where another benefit of the use of precision laser ablation comes in with the use of the photo-polymer. The same precision ablation that etches the trenches for the optical switch can be used to place slots for fiber placement and attachment when connecting the switch nodes to the outside world. FIGS. 22 and 23 show the basic design concept of ablation slots for the laser ablation and fiber placement. FIG. 22 is a top view of fiber-pigtail ablation slots, while FIG. 23 presents a side view of fiber pigtail insertion to multi-layer waveguide design.

As mentioned in the waveguide section, there is a near loss-less coupling of optical power between various diameters of optical fiber and the photo-polymer waveguides. With the implementation of precision ablation, a near loss-less and environmentally resilient (vibration, etc) connection between the glass and polymer waveguides can be achieved with minimal assembly cost and no active alignment. The fiber pigtailing technique described allows minimization of the polymer waveguide circuit for a very small device footprint and minimized optical losses.

Each of the key design elements relating to a fluid-based, TIR optical switch have been presented along with various new ways to improve upon the performance of current designs. Some of the several improvements include novel waveguide design techniques for reducing the numerical aperture of a waveguide, unique methods of trench formation resulting in reduced optical losses in the reflection state, high-speed actuation mechanisms, low-loss fiber pigtail techniques, and “plumbing” designs that allow for the precise placement of the critical fluid/air interface. By effectively combining these various design and manufacturing elements, a high-speed (˜microseconds), low-loss (<0.3 dB per node), high-channel count (4×8 and more), environmentally stable (vibration and temperature) all optical switch can be built. Persons skilled in the art may perceive variations on the described designs, presented as examples of the invention, that may deliver the benefits of the invention in an altered configuration. Such modifications are considered to be within the scope of the invention. Only by reference to the following claims, not to the specific embodiments described above, may a person skilled in the art ascertain the scope of the invention.

We claim:

1. A photo-polymer based fiber-optic switch comprising:
polymer waveguides for input and output signals;
a dynamic fluid-controlled trench formation situated at the junction of input and output waveguides, said trench formation reflecting optical signals from the input signal waveguide to a first output waveguide when devoid of fluid and conducting input signals through the trench to a second output waveguide when filled with fluid;
a piezo controlled actuator, said actuator mounted adjacent to a diaphragm, the operation of said diaphragm controlling the flow of fluid into and out of the trench, said actuator further comprising a fluid reservoir that supplies fluid to fill the trench and conduct optical signals.
